(19) United States
(12) Patent Application Publication
(10) Pub. No.: US 2024/0000019 A1
(43) Pub. Date: Jan. 4, 2024

(54) DEVICE FOR REMOVING THE HUSK OF A CORNCOB

(71) Applicant: Josef Gelbmann, Wallern (AT)

(72) Inventor: Josef Gelbmann, Wallern (AT)

(21) Appl. No.: 18/038,569

(22) PCT Filed: Nov. 24, 2020
(86) PCT No.: PCT/AT2020/060418

§ 371 Date: May 24, 2023

(51) Int. Cl. A01F 11/06; A01F 12/18; A01F 12/10

(52) U.S. Cl. CPC A01F 11/06; A01F 12/10; A01F 12/18

(57) ABSTRACT

The aim of the invention is to remove the husks of a corncob while preventing the corncob from being crushed. This is achieved in that the device is equipped with a working region (A) for arranging a corncob (2) along a longitudinal axis (X), said working region being divided into a first sub-region (A1) and a second sub-region (A1) along the longitudinal axis (X). Furthermore, a gripping unit (B1) is provided which is designed to carry out a gripping process in a first base position (G1), which is located in the first sub-region (A1), in order to grip a first part of the husks (20′) of the corncob (2). Additionally, a first guide unit (FE1), preferably a driven first guide unit (FE1), is provided for the first gripping unit (B1), wherein the first guide unit (FE1) is designed to move the first gripping unit (B1) from the first base position (G1) along a first movement path (P1) in order to exert a lateral force (Fly), which runs outwards laterally relative to the longitudinal axis (X), onto the first part of the husks (20′) and remove the first part of the husks (20′) from the corncob (2) in a radial direction.

The present invention relates to a device and to a method for removing the husks of a corncob.

A (cultivated) corn plant comprises a corn stalk with alternately arranged leaves. In addition, a number of axillary infructescences, in which female inflorescences are located, form on a corn plant. The infructescences are covered by husks (also referred to as sheath leaves or ears) and connected to the corn stalk via a cob stem. After pollination of the female flowers, corn kernels develop on the infructescences, wherein, depending on the location and the light conditions, one or more cobs usually develop fully per corn plant. Furthermore, stigmas (also referred to as corn silk or corn beard) are formed between the infructescence, on which the corn kernels are located, and the husks.

The infructescence thus comprises the corncob with corn kernels, surrounded by husks. In the maturity stage, the fibrous stigmas located at the cob tip of the corncob are at least partially surrounded by the husks and at least partially dried. When harvesting the infructescence, the cob stem is separated from the corn stalk in its entirety or the cob stem is cut. Therefore, after harvesting, at least part of the cob stem is located on the infructescence. It is provided that during harvesting or thereafter, the husks are removed from the corncob. Several methods are known for this purpose, often using counter-rotating rollers arranged along the longitudinal axis of the corn cob. These rollers are used to pull the husks off the corncob tangentially, with the risk of crushing the corncobs, in particular the corn kernels.

It is an object of the present invention to provide a device and a method for removing the husks of a corncob while preventing the corncob from being crushed.

According to the invention, this object is achieved by a device equipped with a working region for arranging a corncob along a longitudinal axis, said working region being divided into a first sub-region and a second sub-region along a longitudinal axis. A first gripping unit is provided which is designed to carry out a gripping process in a first base position, which is located in the first sub-region, in order to grip a first part of the husks of the corncob. A first guide unit, preferably a driven first guide unit, is provided for the first gripping unit, which is driven to move the first gripping unit from the first base position along a first movement path in order to exert a lateral force, which runs outwards laterally relative to the longitudinal axis, onto the first part of the husks and remove the first part of the husks from the corncob in a radial direction.

The object is furthermore achieved by a method, wherein a corncob is arranged longitudinally along a longitudinal axis in a working region, wherein the working region is divided into a first sub-region and a second sub-region along the longitudinal axis, wherein a first part of the husks is gripped in the first sub-region by a first gripping apparatus being in a first base position, wherein the first gripping unit is moved by means of a first guide unit, preferably a driven first guide unit, from the first base position along a second predetermined movement path, so that a lateral force, which runs outwards laterally relative to the longitudinal axis, is exerted onto the first part of the husks and the first part of the husks is removed from the corncob in a radial direction.

By gripping and then removing the first part of the husks in a radial direction, the corn kernels located on the corncob are not crushed, as is often the case with a tangential removal, in particular by (in particular rubberized) rollers arranged in the longitudinal direction.

It is advantageous if a holding unit is provided which is designed to hold the corncob counter to the first lateral force along the longitudinal axis in order to ensure a particularly clean removal of the first part of the husks.

Preferably, the first sub-region is designed such that and the first base position is arranged in the first sub-region such that during a gripping process of the first gripping unit the first part of the husks is gripped in the region of a cob tip of the corncob. This allows the first part of the husks to be removed particularly efficiently, while also removing at least part of the stigma of the corncob.

Advantageously, a second gripping unit is provided, which is designed to carry out a gripping process in a second base position, which is located in the second sub-region, in order to grip a second part of the husks of the corncob, wherein a second guide unit, preferably a driven second guide unit, is provided for the second gripping unit in order to move the second gripping unit from the second base position along a second predetermined movement path in order to exert a lateral force, which runs outwards laterally relative to the longitudinal axis, onto the second part of the husks on the corncob and remove the second part of the husks from the corncob in a radial direction.

The second gripping unit can be regarded as a holding unit counter to the first lateral force, while the first gripping unit can be regarded as a holding unit counter to the second lateral force. This ensures that the corncob remains arranged along the longitudinal axis in order to efficiently remove the first part and the second part of the husks from the corncob.

The first and/or second guide unit can be driven or non-driven. “Non-driven” in relation to the guide unit means “not directly driven by the device itself,” wherein the guide unit can, of course, still be designed to be movable along the associated movement path. A non-driven guide unit can thus be driven indirectly. For example, the second gripping unit can be moved in a “non-driven” manner along the second movement path in accordance with the second guide unit, while the first gripping unit is moved along the first movement path by means of an actively driven guide unit. The first lateral force acts via the first gripping unit from the first guide unit via the first part of the husks onto the corncob, and from the corncob further via the second part of the husks onto the second guide unit, whereby the second lateral force is generated onto the second part of the husks. The second part of the husks is connected to the second guide unit via the second gripping unit. Since the second guide unit is movable along the second movement path, the second lateral force acting on the second gripping unit generates the movement of the second gripping unit along the second movement path. The second guide unit specifies merely the second movement path.

It is also conceivable for the first and second guide unit to be each non-driven. For example, the corncob can be provided with a feed force after the respective gripping units have closed. Since the husks are gripped by the gripping units, this feed force acting on the corncob causes a force acting on the husks connected to the corncob. This force comprises a lateral force which, in turn, acts from the husks onto the gripping units which thus move along the predetermined movement path. Thus, the first/second guide unit specifies merely the first/second movement path, wherein the lateral forces are generated indirectly via the feed force.

Preferably, the first and second base positions are provided diametrically about the longitudinal axis, preferably adjacent to one another.

The respective movement paths can be symmetrical to one another along the longitudinal axis. It can thus be ensured that the first part of the husks and the second part of the husks are removed uniformly from the corncob.

Preferably, the first guide unit comprises a first base body on which the first gripping apparatus is arranged, and the second guide unit comprises a second base body on which the second gripping apparatus is arranged, wherein particularly preferably the first and second gripping apparatuses are each arranged in a recess of the associated base body.

The first guide unit can be designed such that the first movement path comprises a first arc movement lateral relative to the longitudinal axis, preferably a rotation about a first rotational axis arranged laterally relative to the longitudinal axis in a first rotational direction, wherein the second guide unit is designed such that the second movement path comprises at least a second arc movement lateral relative to the longitudinal axis counter to the first arc movement, preferably a rotation about a second rotational axis arranged laterally relative to the longitudinal axis in a second rotational direction and counter to the first rotational direction.

If the first and second base bodies are each designed to be rotationally symmetrical, the husks can be removed particularly efficiently, in particular when the movement path comprises an arc movement.

The guide units can also be designed such that the first movement path and the second movement path comprise a mutually counter-rotating linear movement lateral relative to the longitudinal axis. Of course, the movement paths can also comprise superimposed linear movements and arc movements. It is also possible fora part of these movements are carried out by a drive (e.g., an arc movement) and for another part to be non-driven, for example a linear movement in the lateral direction, for example for adapting to the changed cross-section of the corncob. This non-driven movement can be effected by a spring force acting inwards in the guide unit and the cross-section of the corncob causing movement outwards counter to the spring force.

Advantageously, at least one gripping unit, preferably the first and second gripping unit, comprises at least one gripping element that is displaceable, preferably displaceable laterally relative to the longitudinal axis, for carrying out the gripping process.

It is particularly advantageous if at least one gripping unit, preferably the first and second gripping unit, each comprise two gripping elements that are displaceable in opposite directions for carrying out the gripping process, preferably displaceable in opposite directions laterally relative to the longitudinal axis.

In addition, a feed unit can be provided which is designed to position the corncob in the working region, whereby it can be ensured that the husks are gripped by the gripping units provided for this purpose. The feed unit can also fulfill the function of the holding unit in order to hold the corncob counter to the first lateral force (and possibly counter to the second lateral force) along the longitudinal axis in order to ensure a particularly clean removal of the first part (and possibly the second part) of the husks.

A sensor unit can also be provided, which detects whether a corncob is correctly arranged in the working region, wherein it can additionally be provided that method steps for detecting and/or removing the husks are approved only if a corncob has been detected.

Preferably, a cutting device for cutting off a cob stem from the corncob is provided, preferably comprising two knives, particularly preferably each having a v-shaped or concave blade, which is preferably located downstream of the working region.

Furthermore, a positioning apparatus can be provided which is designed to orient the corncob with the cob tip upward after removal of the husks, wherein the positioning apparatus is preferably designed as a down pipe mounted to be axially rotatable to one side. The corncob can thus be further processed after removal of the husks; for example, to be removed from the cob stem by means of a cutting device. The positioning apparatus can also fulfill the function of the holding unit in order to hold the corncob counter to the first lateral force (and possibly counter to the second lateral force) along the longitudinal axis in order to ensure a particularly clean removal of the first part (and possibly the second part) of the husks.

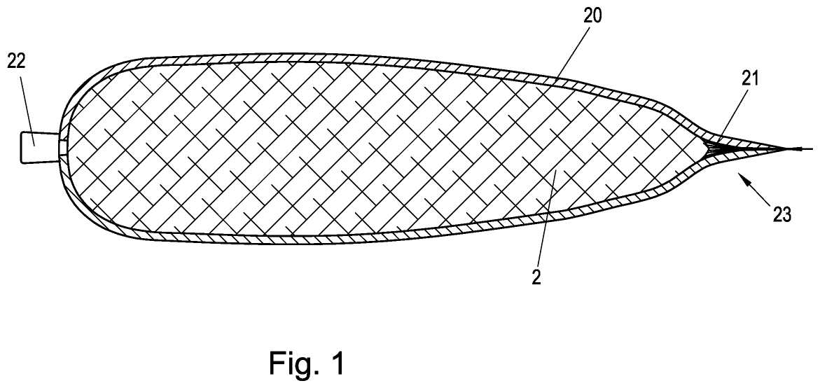

The present invention is described in greater detail below with reference to FIGS. 1 to 3d which show, by way of example, advantageous embodiments of the invention in a schematic and non-limiting manner. The following are shown:

FIG. 1 shows a longitudinal section through an infructescence of a corn plant,

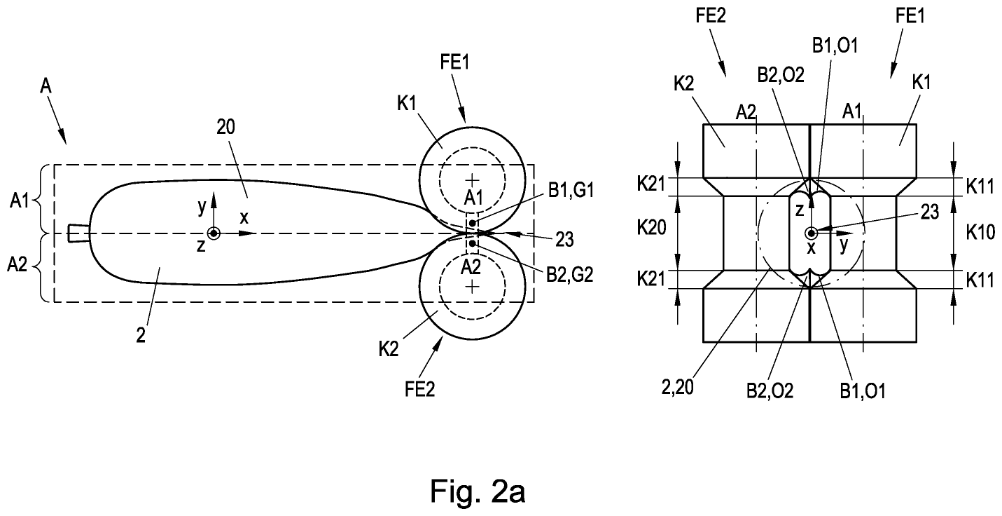

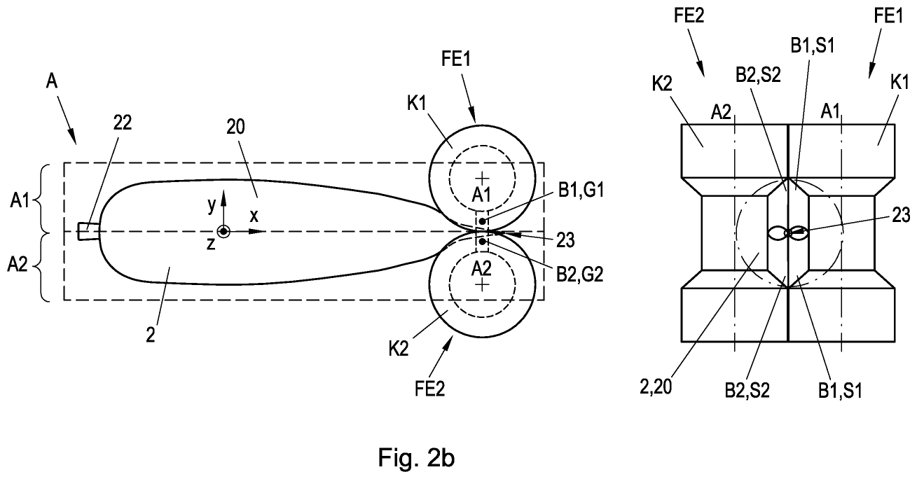

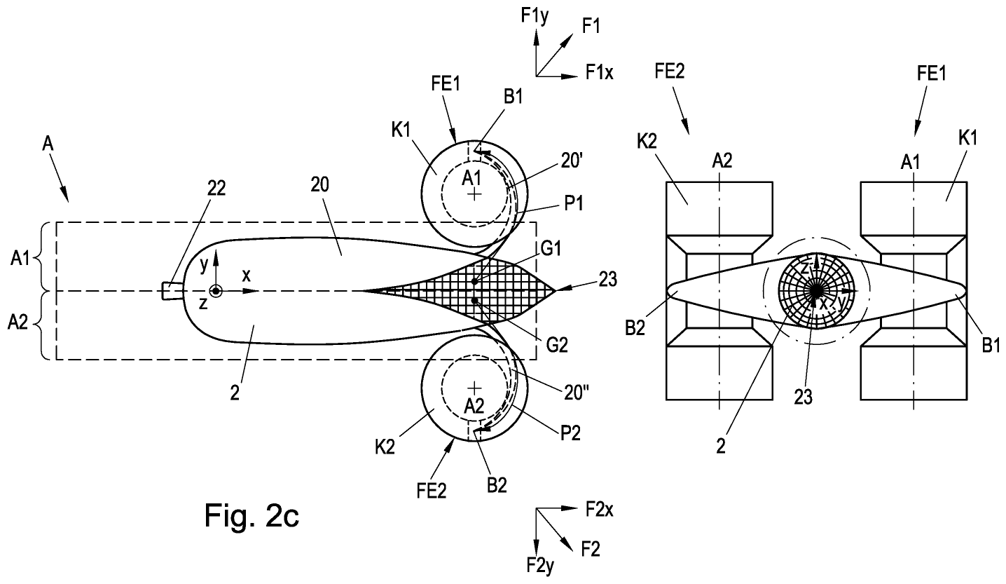

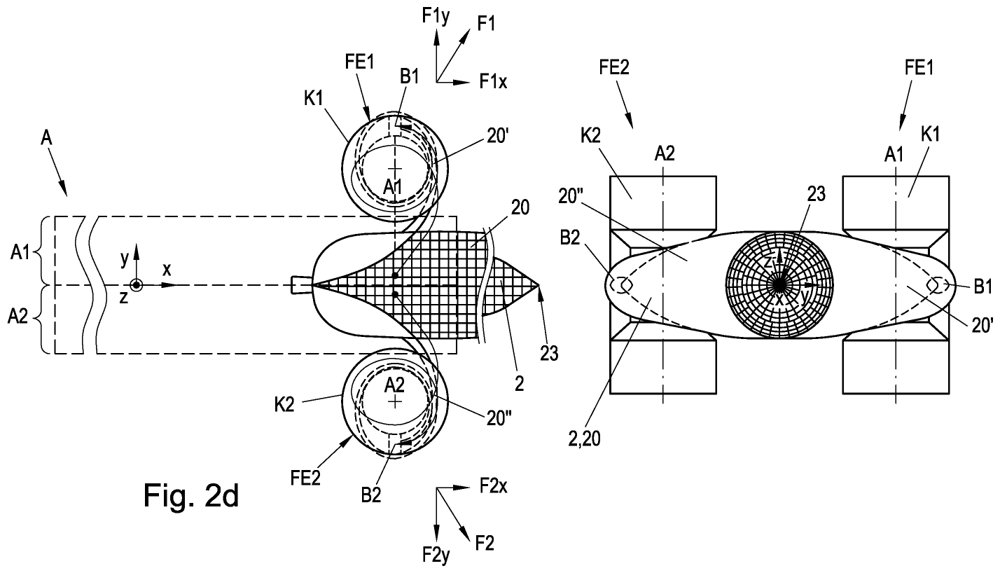

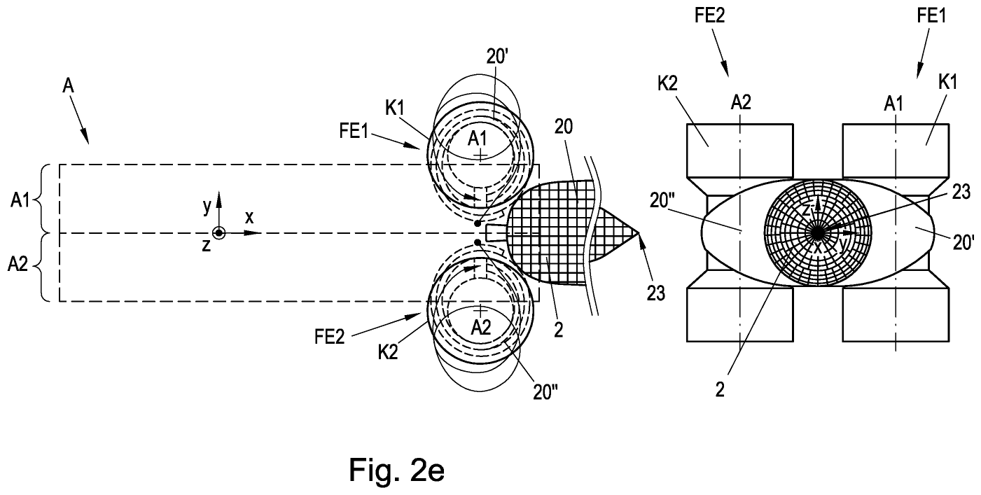

FIG. 2a shows a device for removing the husks of a corncob with gripping units in the base position,

FIG. 2b shows the device after the gripping process has been carried out,

FIG. 2c shows the device with the husks partially removed,

FIG. 2d shows the device with the husks largely removed,

FIG. 2e shows the device with the husks completely removed

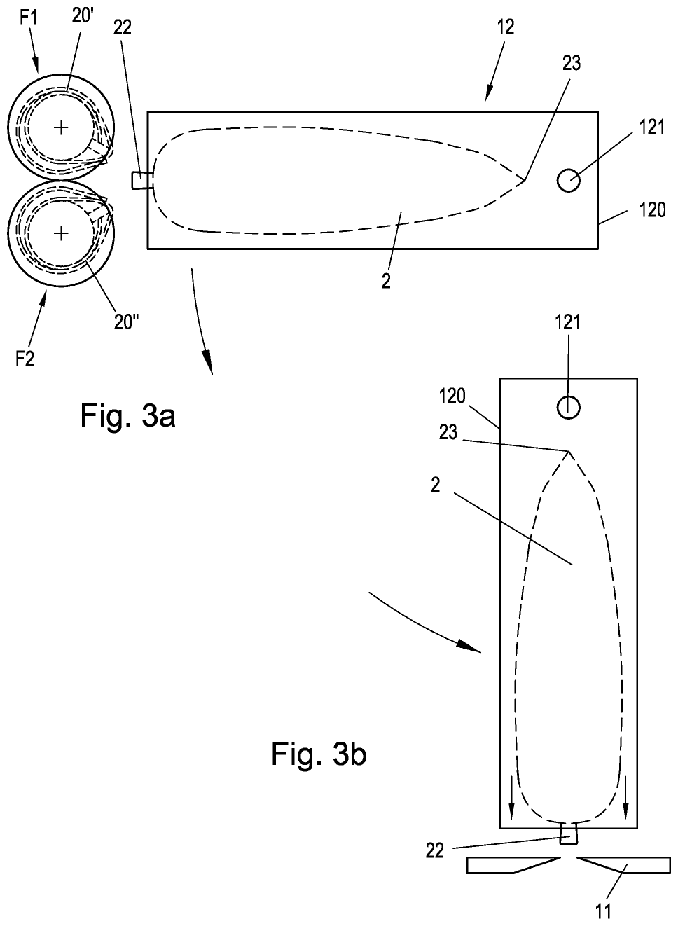

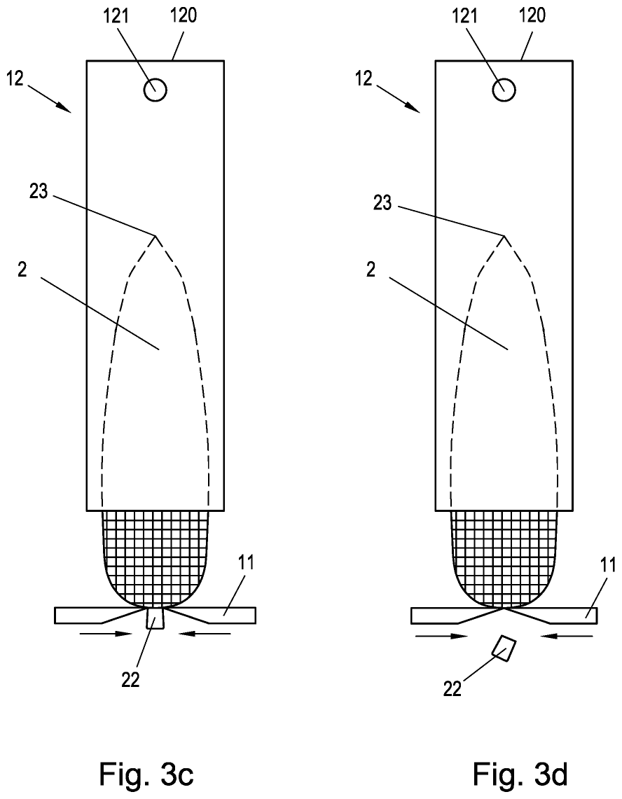

FIG. 3a shows a positioning apparatus in a receiving position,

FIG. 3b shows the positioning apparatus in a removal position,

FIG. 3c shows a cutting apparatus prior to separating the corn stem,

FIG. 3d shows the cutting apparatus after separating the corn stem.

FIG. 1 shows a longitudinal section through an infructescence of a corn plant. The infructescence comprises the actual corncob 2 with corn kernels (not shown in FIG. 1), which is surrounded by husks 20. The corncob 2 has an elongated shape, has a cob tip 23 at a front axial end, and is rounded at a rear axial end. The rear end can have a cob stem 22 which, after harvesting, often remains on the infructescence. The husks 20 extends from the rear part of the corncob 2 at least partially beyond the cob tip 23. In the area of the cob tip 23, stigma 21 are arranged between the corncob 2 and the husks 20, which may also protrude beyond the husks 20 and thus be visually visible. Corncobs 2 can be asymmetrical in shape because they are a natural product and because the corncobs 2 rest against the corn stalk with one side and face away from the corn stalk with another side.

A corncob 2 is arranged in a working region A according to FIG. 2a. This can be done manually, or also by a feed unit 10 which is designed to position the corncob 2 in the working region A.

The figures use a Cartesian coordinate system to describe the orientations, where x denotes the positive longitudinal direction (“front”) and −x denotes the negative longitudinal direction (“rear”) along a longitudinal axis X, and y denotes the positive lateral direction (“left”) and −y denotes the negative lateral direction (“right”) along a lateral axis Y. The lateral axis Y and the longitudinal axis X are normal to one another. According to a right-handed helix, z represents the positive height direction (“top”) and −z represents the negative height direction (“bottom”) along a vertical axis Z, which is normal to the lateral axis Y and the longitudinal axis X. The origin of the coordinate system is exemplarily placed in the center of the working region A. FIGS. 2a, 2b, 2c, 2d, 2e each show a plan view (i.e., the xy-plane) and a front view (i.e., the xz-plane) of the device according to the invention.

The corncob 2 is oriented along the longitudinal axis x, wherein it is provided here that the cob tip 23 of the corncob 2 lies in the positive longitudinal direction x, i.e., in the front. The working region A is divided into a first sub-region A1 and a second sub-region A2 along the longitudinal axis X. The working region A can basically be two-dimensional or three-dimensional, wherein in the depicted embodiment a two-dimensional working region A lying in the xy-plane is present, which is divided by the xz-plane into the first and second sub-regions A1, A2. The first and second sub-regions A1, A2 do not have to be constructively recognizable, but serve, in particular, for describing the effect of the further elements, such as the gripping unit B1, etc. Of course, the division of the working region A into the first and second sub-regions A1, A2 can also be constructively recognizable. One part of the corncob 2 (a first longitudinal half) is located in the first sub-region A1 and another part (a second longitudinal half) is located in the second sub-region A2. For this positioning, a suitable insert container can be provided in the working region A, for example.

In FIG. 2a, the corncob is still covered by its husks 20. A first gripping unit B1 and preferably a second gripping unit B2 are provided, which are each in a base position G1, G2 in FIG. 2a. The first base position G1 of the first gripping unit B1 is provided in the first sub-region A1, the second base position G2 of the second gripping unit B2 in the second sub-region A2. In FIGS. 2a to 2e, the respective base positions G1, G2 of the gripping units B1, B2 are arranged diametrically about the longitudinal axis X and adjoin one another at the longitudinal axis X, which means that the first base position G1 is in the positive lateral direction y and the second base position G2 is in the negative lateral direction −y.

The first gripping unit B1 is designed to carry out a gripping process in the first base position G1 in order to grip a first part of the husks 20′ of the corncob 2. The second, optional gripping unit B2 can be designed to carry out a gripping process in the second base position G2 in order to grip a second part of the husks 20″ of the corncob 2. If it is intended to remove only the first part of the husks 20′ and to leave the rest of the husks on the corncob 2, the second gripping unit G2 can be omitted. In the figures, both a first gripping unit G1 and a second gripping unit G2 are depicted, but this represents merely a preferred embodiment.

In order to carry out the gripping process, the gripping unit B1 is brought from an open position O1 into a closed position S1, with the first part of the husks 20′ being respectively gripped in the closed position S1.

If a second gripping unit B2 is provided, it can also be brought from an open position O2 into a closed position S2 for carrying out the gripping process, with the second part of the husks 20″ being gripped in the closed position S2.

Preferably, the first gripping unit B1 comprises at least one gripping element that can be displaced in order to carry out the gripping process. If a second gripping unit B2 is provided, it can also comprise a gripping element that can be displaced in order to carry out the gripping process.

By displacing the gripping element, e.g., along the vertical axis Z, the first and optionally second part of the husks 20′, 20″ is respectively clamped in the associated gripping unit B1, B2 by the gripping element, e.g., respectively in a counter-pressure element provided on the gripping unit B1, B2.

Particularly advantageously, the gripping units B1, B2 each comprise two gripping elements that can be displaced in opposite directions for carrying out the gripping process. By displacing the gripping elements of the first gripping unit B1, e.g., along the vertical axis Z, the first part of the husks 20′ is clamped between these gripping elements and, analogously, by displacing the gripping elements of the second gripping unit B2, e.g., along the vertical axis Z, the second part of the husks 20″ is clamped between these gripping elements, as is also indicated in the figures. It is advantageous if the gripping elements comprise one or more teeth oriented in the displacement direction in order to securely grip the husks 20. The gripping elements shown each have a tooth.

Advantageously, a first guide unit FE1 is provided for the first gripping unit B1 which is driven to move the first gripping unit B1 from the first base position G1 along a first movement path P1. Additionally, a second guide unit FE2 can be provided for the second gripping unit B2 (if provided), which may be driven to move the second gripping unit B2 from the second base position G2 along a first movement path P2.

Advantageously, the first guide unit FE1 comprises a first base body K1, on which the first gripping apparatus B1 is arranged. Advantageously, the second guide unit FE2 comprises a second base body K2, on which the second gripping apparatus B2 is arranged. It is particularly advantageous if the first gripping apparatus B1 (and, if provided, the second gripping apparatus B2) is arranged at a recess K10, K20 of the associated base body K1, K2. Here, the recesses K10, K20 are arranged centrally with respect to the vertical axis Z only by way of example, but may also be arranged decentrally.

The depicted base bodies K1, K2 are each designed to be rotationally symmetrical so as to each represent a roller oriented along the vertical axis Z with a cross-section reduced in the region of the recess K10, K20. The transition region K11, K20 of the region of the base body K1, K2, which has the original cross section, can be chamfered so as to ensure an automatic centering of the cob tip 23 in the region of the recess K10, K20 and thus in the region of the gripping apparatuses B1, B2.

FIG. 2a depicts the gripping units B1, B2 each in an open position O1, O2, with gripping elements being respectively provided here, which are each spaced apart from one another, i.e., open, along the vertical axis X, thus exposing the recess of the respective base body G1, G2. The gripping process then takes place by a transition from the open position O1, O2 to the closed position S1, S2. In FIG. 2a, the arrows indicate that the gripping process of the first and second gripping units B1, B2 is in each case carried out by a displacement, in opposite directions, of the associated gripping elements in the recess of the guide unit FE1, FE2 along the vertical axis Z.

Preferably, at least one sensor unit is provided in order to detect whether a corncob 2 is correctly arranged in the working region A and, if detection is successful, to allow the gripping process and/or other method steps such as, for example, the subsequent defoliation to take place

After completion of the gripping process (FIG. 2b), the first part of the husks 20′ is gripped by the first gripping unit B1. If a second gripping unit B2 is provided as shown, the second part of the husks 20″ is gripped by the second gripping unit B2 after completion of the gripping process, as shown in FIG. 2b.

In order to remove the husks 20 from the corncob 2, the first guide unit FE1 is designed to move the first gripping unit B1 from the first base position G1 along a first predetermined movement path P1. Furthermore, the second guide unit FE2 (if provided) is designed to move the second gripping unit B2 from the second base position G2 along a second predetermined movement path P2. If the guide units FE1, FE2 each comprise base bodies K1, K2 on which the respective gripping elements B1, B2 are arranged, the corresponding movement path P1, P2 of the gripping elements B1, B2 can be generated by a movement of the base bodies K1, K2. As mentioned, the first/second guide unit FE1 is designed to move the first/second gripping unit B1/B2 from the first/second base position G1 along a first/second movement path P1/P2. For this purpose, e.g., the base bodies K1, K2 can be moved electrically, hydraulically, pneumatically, etc. as part of the associated guide unit FE1, FE2 and along rails, belts, etc., whereby the guide units FE1, FE2 can each have electrical and/or hydraulic and/or pneumatic elements as well as rails, belts, etc. in order to move the gripping elements B1, B2 (arranged, e.g., on base body K1, K2) along the movement paths P1, P2. To simplify the illustration, no detailed embodiments of the guide units FE1, FE2 are shown in the figures except for the base bodies K1, K2.

The movement path P1, P2 can have components not only along the lateral axis Y and the longitudinal axis X, but also along the vertical axis Z. However, it is advantageous for the movement path P1, P2 to lie exclusively in the xy-plane, i.e., for no components to be provided along the vertical axis Z.

As a result of the movement paths P1, P2 of the gripping units B1, B2 (predetermined by the guide units FE1, FE2), a first force F1 acts on the first part of the husks 20′ by means of the first gripping unit B1, and a second force F2 acts on the second part of the husks 20″ by means of the second gripping unit B2. The first force F1 has a lateral force Fly as a component in the positive lateral direction y, the second force F2 has at least one component as lateral force F2y in the negative lateral direction −y.

The first and second base bodies K1, K2 are preferably mounted such as to be movable along the lateral axis Y so that they rest against the corncob 2. It can also be provided for the base bodies K1, K2 to be pressed towards one another with a suitable (spring) force, it being important to ensure that the corncobs are not crushed.

Although an arc movement, here basically a rotational movement with superimposed linear movement in the lateral direction, of the gripping units B1, B2 is shown by rotation of the base bodies K1, K2 in the figures, it is also conceivable for a linear movement driven in a counter-rotating manner along the lateral axis Y to be carried out in order to pull the respective parts 20′, 20″ of the husks 20 away from the corncob 2 and apart in a lateral direction. Thus, the respective movement path P1, P2 would lead along the lateral axis Y (i.e., the first movement path P1 would lead in the positive lateral direction x and the movement path P2 would lead in the negative lateral direction −y). Thus, the forces F1, F2 would correspond to the respective lateral forces Fly, F2y. Of course, combinations of rotational movements and linear movements along the lateral axis Y not shown in the figures are also possible. It is important that a lateral force F1y (and optionally F2y), which runs outwards laterally relative to the longitudinal axis X, acts on the first part of the husks 20′ (and, if a second gripping unit B2 is provided, on the second part of the husks 20″) in order to remove the first part of the husks 20′ (and optionally the second part of the husks 20″) from the corncob 2 in a radial direction.

The movement path P1, P2 can be generated by driving the guide elements FE1, FE2. Components of the movement path P1, P2 can also be generated by a drive of the guide elements FE1, FE2, and components of the movement path P1, P2 can be designed to be non-driven. It can also be provided for components of the movement path P1, P2 to be driven passively. For example, the shown in the figures, rotational components of the movement paths P1, P2 which rotate around the rotational axes R1, R2 can be actively driven, and the linear component of the movement paths, i.e., the linear movement of the rotational axes R1, R2 along the lateral axis Y, can be passively provided. The passive movement results, for example, from adapting the position of the rotational axes R1, R2 to the cross section of the corncob 2, e.g., by applying a spring force inwards, i.e., towards the longitudinal axis X. Here, it should be noted that the spring force is in an order of magnitude which does not result in the corn kernels being crushed.

The lateral forces Fly, F2y are directed in opposite directions, as a result of which the corncob 2 is moved in the positive longitudinal direction x as a result of the resulting tension between the first part of the husks 20′ and the second part of the husks 20″. If the movement path P1, P2 is designed such that the husks 20 are not only stretched completely, but is overstretched, the husks are removed from the corncob 2.

As mentioned, the first guide unit FE1 can be designed such that the first movement path P1 comprises at least a first arc movement, preferably a rotation about a first rotational axis A1 arranged laterally relative to the longitudinal axis X in a first rotational direction R1. Furthermore, the second guide unit FE2 (if present) can be designed such that the second movement path P2 comprises at least a second arc movement counter to the first arc movement, preferably a rotation about a second rotational axis A2 arranged laterally relative to the longitudinal axis X in a second rotational direction R2 counter to the first rotational direction R1.

This is shown in FIGS. 2c, 2d and FIG. 2e, wherein the first and second rotational axis R1, R2 extend parallel to the vertical axis Z, and the first and second base body K1, K2 rotates about the associated rotational axis R1, R2. In FIG. 2c, a rotation by 180 degrees was carried out respectively, the rotation was carried out further (for example two to three revolutions) in FIG. 2d, and in FIG. 2e the rotation was carried out to such an extent that the first part of the husks 20′ was spooled, i.e., wound, onto the first guide unit FE1 (and the second part of the husks 20″ onto the second guide unit FE2).

The rotational movement may also proceed to separate the husks 20 entirely from the corncob 2 after they have been spooled onto the base body K1, K2. After separating, the husks 20 can fall off the base body K1, K2. Preferably, the base bodies K1, K2 are subsequently rotated in the opposite direction, preferably in a jerky manner, thus loosening any husks still left on the base bodies K1, K2.

In the figures, the movement paths P1, P2 are shown as a solid arrow, which is composed of a rotation about the rotational axes A1, A2 and a linear movement in the lateral direction Y, wherein the figures each show the movement path P1, P2 traveled so far. Thus, the movement paths P1, P2 in FIG. 2c are composed of a 180 degree rotation about the rotational axes A1, A2 with a superimposed outward directed linear movement in the lateral direction Y, wherein in FIG. 2d the rotation about the rotational axes A1, A2 and also the linear movement in the lateral direction Y is more advanced. In FIG. 2e, the rotation about the rotational axes A1, A2 is even more advanced, wherein an inward directed linear movement in the lateral direction Y is also superimposed. Thus, the movement path P1, P2 each represents a spiral displaced along the lateral direction Y (first to the outside and then to the inside).

It should be noted that the action of the forces F1, F2 does not have to correspond to the movement of the respective gripping unit B1, B2 along the associated movement path P1, P2, since the forces F1, F2 acting on the parts of the husks 20′, 20″ on the corncob 2 are considered. Thus, in particular if the movement paths P1, P2 include an arched portion (e.g., in the form of a rotational portion), it may be the case that the movement path P1, P2 has a component in the negative longitudinal direction −x, as shown in FIG. 2d, or if a further rotation by 90° takes place, even counter to the associated lateral force Fly, F2y.

Of course, the movement paths P1, P2 can each comprise portions of simultaneous (i.e., mixed) or sequential rotational movements and lateral movements. However, it is advantageous if in the beginning a lateral movement takes place at least partially in order to remove the gripping units B1, B2 from one another and not crush the corncob 2 in the further course, since the cob tip 23 has a smaller diameter than the central part of the corncob 2. In FIG. 2c, the movement paths P1, P2, for example, first show a rotation about the rotational axis A1, A2, which is superimposed with a linear movement towards the outside (i.e., in the positive lateral direction for the first movement path P1 and in the negative lateral direction Y for the second movement path P2). In FIG. 2d, the movement paths P1, P2 continue in the form of a rotation about the rotational axis A1, A2 with a superimposed linear movement in the positive/negative lateral direction Y. In FIG. 2e, the respective movement path P1, P2 continues as a rotation about the rotational axis A1, A2, but is superimposed with an inward facing linear movement (i.e., in the negative lateral direction for the first movement path P1 and in the positive lateral direction Y for the second movement path P2). This is particularly advantageous if the cross-section of the corncob 2 decreases in the region of the guide unit FE1, FE2, as in FIG. 2e, where the corncob 2 has advanced so far in the positive longitudinal direction X that its stem is located in the region of the guide unit FE1, FE2. Despite these rotational movement paths P1, P2 with superimposed linear movements in the positive and negative lateral directionY, a lateral force Fly, F2y, which in each case runs outwards laterally relative to the longitudinal axis X, acts on the first/second part of the husks 20′/20″ in order to remove the first/second part of the husks 20720″ from the corncob 2 in a radial direction.

Furthermore, a positioning apparatus 12 can be provided which is designed to orient the corncob 2 with the cob tip 23 upwards after removal of the husks 20. In FIG. 3a, b, a down pipe 120 rotatably mounted on one side about a pivot axis 121 is shown as positioning apparatus 12, which is located downstream of the working region A such that the corncob 2 is introduced into the down pipe 120 with the cob tip 23 going in first. The pivot axis 121 can also be located outside of the down pipe 120. The down pipe 120 has a front region and a rear region. Preferably, the positioning apparatus 12 is oriented horizontally in a receiving position for receiving the corncob 2. If the corncob is introduced into the down pipe with the cob tip 23 going in first, the cob tip 23 is located in the front region of the down pipe 120 and the cob stem 22 in the rear region of the down pipe 120. The front region of the down pipe 120 is mounted about a lateral pivot axis 121 and is designed to pivot the down pipe about the pivot axis 121 in such a manner into a removal position after the corncob 2 has been introduced. The removal position of the positioning apparatus 12 is preferably arranged vertically, whereby the rear region of the down pipe 120 is oriented downwards, whereby, in turn, the cob tip 23 of the corncob 2 is oriented upwards. If the positioning apparatus 12 is designed as a down pipe 120, pivoting of the down pipe 120 from the receiving position to the removal position can take place by a control unit performing a rotation of the down pipe 120 about the pivot axis 121. However, pivoting can also be caused by the mass of the corncob 2. If the positioning apparatus 12 (here the down pipe 120) is in the removal position, the corncob 2 can be removed, which, due to gravity, can take place without external action.

Furthermore, a cutting device 11 for cutting off a cob stem 22 from the corncob 2 can be provided. This cutting device 11 can comprise one, two or more knives, preferably at least partially with a v-shaped or concave blade, which are moved towards each other with the blade in order to cut off the cob stem 22 from the corncob 2. An exemplary cutting device 11 is shown in FIGS. 3c and 3d, wherein here the cutting device 11 is located downstream of the working region A. This means that the corncob 2 is first (at least in part) freed from the husks 20 and then the cob stem 22 is removed. Of course, the cob stem can also be located upstream of the working region A, whereby the cob stem 22 is removed prior to the removal of at least part of the husks 20.

It is particularly advantageous if a positioning apparatus 12 is located downstream of the working region A and, furthermore, if a cutting device 11 is located downstream of the positioning apparatus 12. Thus, the corncob 2 can be fed directly from the removal position of the positioning apparatus 12 to the cutting device 11. Thus, the corncob 2 can first be oriented into a removal position after the removal of the husks 20, and then the cob stem 22 can be removed. In the embodiment according to FIG. 3b, the corncob 2 is fed by the positioning apparatus 12 in the removal position of the cutting device 11 due to its mass.

Furthermore, a further positioning apparatus can be located upstream of the cutting device 11 (not shown), which can be located downstream of a positioning apparatus 12 (if provided) in order to bring the corncob 2 into a suitable position for removing the cob stem 22. For this purpose, the further positioning apparatus can comprise an elongated slot having a width which is greater than a conventional cob stem 22, but smaller than a conventional corncob 2. For example, the cob stem is positioned in the elongated slot due to its mass, whereupon the further positioning apparatus rotates and thus centers the cob stem in the center of the elongated slot. Preferably, the cutting device 11 (e.g., the tip of the v-shaped blade(s)) is arranged in the center of the elongated slot, thus, separating the cob stem 22 can take place.

1. A device for removing the husks of a corncob, comprising:
a working region, wherein the working region is provided for arranging a corncob along a longitudinal axis and is divided into a first sub-region and a second sub-region along the longitudinal axis;
a first gripping unit is provided which is configured to carry out a gripping process in a first base position which is located in the first sub-region in order to grip a first part of the husks of the corncob; a first guide unit is provided for the first gripping unit, wherein the first guide unit is configured to move the first gripping unit from the first base position along a first movement path in order to exert a lateral force, which runs outwards laterally relative to the longitudinal axis, onto the first part of the husks and remove the first part of the husks from the corncob in a radial direction.

2. The device according to claim 1, wherein the first base position is arranged in the first sub-region such that during a gripping process of the first gripping unit the first part of the husks is gripped in the region of a cob tip of the corncob.

3. The device according to claim 1, further comprising:
a second gripping unit which is configured to carry out a gripping process in a second base position, which is located in the second sub-region, in order to grip a second part of the husks of the corncob;
a second guide unit, is provided for the second gripping unit, wherein the second guide unit is configured to move the second gripping unit from the second base position along a second predetermined movement path in order to exert a lateral force, which runs outwards laterally relative to the longitudinal axis, onto the second part of the husks on the corncob and remove the second part of the husks from the corncob in a radial direction.

4. The device according to claim 3, wherein the second base position is arranged in the second sub-region such that during a gripping process of the second gripping unit the second part of the husks is gripped in the region of the cob tip of the corncob.

5. The device according to claim 3, wherein the first and second base positions are provided diametrically about the longitudinal axis.

6. The device according to claim 3, wherein the respective movement paths along the longitudinal axis are symmetrical to one another.

7. The device according to claim 3, wherein the first guide unit comprises a first base body on which the first gripping apparatus is arranged, and the second guide unit comprises a second base body on which the second gripping apparatus is arranged.

8. The device according to claim 7, wherein first and second gripping apparatuses are each arranged in a recess of the associated base body.

9. The device according to claim 3, wherein the first and second base bodies are each designed to be rotationally symmetrical.

10. The device according to claim 3, wherein the first guide unit is designed such that the first movement path includes a first arc movement lateral relative to the longitudinal axis, and wherein the second guide unit is designed such that the second movement path includes at least a second arc movement lateral relative to the longitudinal axis counter to the first arc movement.

11. The device according to claim 3, wherein the guide units are designed such that the first movement path and the second movement path comprise a mutually counter-rotating linear movement lateral relative to the longitudinal axis.

12. The device according to claim 3, wherein at least one, gripping unit includes at least one gripping element which is displaceable.

13. The device according to claim 3, wherein at least one, preferably two, gripping units each comprise two gripping elements which are displaceable in the opposite direction.

14. The device according to claim 1, wherein a feed unit is provided which is designed to position the corncob in the working region.

15. The device according to claim 1, wherein a positioning apparatus is provided which is configured to orient the corncob into a predetermined removal position after removal of the husks.

16. The device according to claim 15, wherein the positioning apparatus is designed to receive the corncob in a horizontal receiving position and to bring it to a vertical removal position for removing the corncob.

17. The device according to claim 16, wherein the positioning apparatus is pivotable about a pivot axis from the receiving position to the removal position.

18. The device according to claim 1, wherein a cutting device is provided, located downstream of the working region, for cutting off a cob stem from the corncob, which includes at least two knives, the blade of which can be displaced relative to one another for cutting off the cob stem, whereas the blade of at least one knife is designed to be v-shaped or concave.

19. (canceled)

20. (canceled)

21. (canceled)

22. A method for removing the husks from corncobs, comprising:
arranging a corncob longitudinally along a longitudinal axis in a working region, wherein the working region is divided into a first sub-region and a second sub-region along the longitudinal axis;
gripping a first part of the husks in the first sub-region by a first gripping apparatus located in a first base position; and
moving the first gripping unit by means of a first guide unit from the first base position along a second predetermined movement path, so that a lateral force, which runs outwards laterally relative to the longitudinal axis, is exerted onto the first part of the husks and the first part of the husks is removed from the corncob in a radial direction.

23. The method according to claim 22, wherein a second part of the husks in the second sub-region is gripped by a second gripping apparatus located in a second base position, and in that the second gripping unit is moved by means of a second guide unit from the second base position along a second predetermined movement path, so that a lateral force, which runs outwards laterally relative to the longitudinal axis, is exerted onto the second part of the husks and the second part of the husks is removed from the corncob in a radial direction.
